(19) United States
(12) Patent Application Publication
(10) Pub. No.: US 2025/0334214 A1
(43) Pub. Date: Oct. 30, 2025

(54) CLOSURE ADAPTER

(71) Applicant: NATIONAL OILWELL VARCO, L.P., Houston, TX (US)

(72) Inventors: Carlos O. Ramirez, Houston, TX (US); Heba M. Ramadan, Cypress, TX (US); Alfredo J. Cabrera, Houston, TX (US); Barry G. Jansma, Spring, TX (US)

(21) Appl. No.: 18/650,448

(22) Filed: Apr. 30, 2024

(51) Int. Cl. F16L 37/10; F16L 23/024

(52) U.S. Cl. CPC F16L 19/0231; F16L 23/024; F16L 19/0206; F16L 19/025

(57) ABSTRACT

An assembly to coupling a pipeline closure with a pipeline closure hub, the pipeline closure hub including a closure hub opening portion and a coupling portion. The coupling including a pipeline closure extension extending from the pipeline closure. The pipeline extension including a junction portion to abut the closure hub opening portion of the pipeline closure hub and a fastener extending around the closure hub.

### TECHNICAL FIELD

Examples described in this document pertain generally, but not by way of limitation, to adapters for converting an existing end cap, or closure, of a vessel or pipeline to an endcap, or closure, that is adjustable after attachment.

### BACKGROUND

Pipelines extend over land and through waterways to transport liquids such as petroleum, crude oil, natural gases, fuel or the like from one point to another. Pipelines are used throughout the world to connect, for example, production areas to refineries or plants, such as to move crude oil from offshore oil rigs or oil fields on land to refineries or plants. In other examples, pipelines are used to transport processed crude oil from refineries or plants to distribution facilities such as terminals for commercial distribution.

Pipelines are tubular structures that include connected tubular pieces, as well as closures to access the interior structures. For example, a closure, such as a hinged closure or a threaded end cap, provides a location for access to internal structures and components of the pipeline. For example, the closure is opened to allow access to pig pipelines, inspect the internal structures of the pipeline, clean the pipeline or provide access for maintenance for the pipeline.

Once a pipeline is constructed, it can be operated for years, and optionally for several decades. The pipeline during this time is subject to environmental degradation, and wear and tear. The closures that are used for inspection and access are also subject to degradation, and wear and tear. Further, operation of the pipelines includes maintenance and inspection to ensure the integrity of the system, which also includes opening or gaining access through the closure. Over time, pipelines are, at times, at risk of deterioration such as cracking or corrosion. Inspection of the pipelines or cleaning assists in maintaining the integrity and structure of the pipeline. Optionally, maintenance is performed on the pipeline where deterioration is present.

An example of a problem to be solved includes providing a closure, or end cap, that replaces an existing end cap such as a replacement for a threaded endcap or a closure threaded on an opening of a terminal of a pipeline. In examples, the threads connecting the closure to pipeline opening are subject to environmental conditions, wear and tear, and degradation over time. In some examples, when threads degrade it can become difficult to unscrew the closure or to tighten the closure. In other examples, when installing a replacement closure, reattaching the closure, or tightening the closure, the wear of the threads may cause the tightened position (e.g., angular position based on amount of rotation) of the closure to change or be different from previous installations. In examples, when the tightened position changes, the closure door may not be plumb causing problems with the operation of the door.

### SUMMARY

The present inventors have recognized, among other things, that a possible solution to replacing a closure or endcap includes providing a replacement closure or an attachment to replace a closure that can be adjusted after installation. The replacement, in some examples includes, an attachment having a fastener (e.g., clamp, bracket, vice or similar coupling) that is coupled with a replacement closure and the attachment mates with the threads on an existing opening portion of a pipeline. In an example, a coupling assembly includes the replacement closure and a fastener. The replacement closure optionally includes an extension (such as a tail sub) that couples the closure with both the opening portion and the threaded fastener.

In embodiments according to the present disclosure, a coupling assembly can connect a pipeline closure (e.g., door, end cap) with an existing pipeline closure hub (e.g., termination portion of the pipeline). In examples, the pipeline closure hub has an opening that provides access to the internal structures of the pipeline. The pipeline closure hub optionally includes an external coupling portion.

In some embodiments, a pipeline closure extension extends from the pipeline closure. The pipeline closure extension is configured, for example, to be positioned in an abutting relationship with the closure hub opening portion. The pipeline closure extension can include a junction portion and the junction portion can include an abutting portion that can be configured to abut the closure hub opening.

The assembly, in some examples, includes a fastener that extends at least partially around an area where the extension portion abuts the opening of an existing pipeline. The fastener optionally includes a closure hub adapter portion that is coupled with the external coupling portion and a pipeline closure extension fastener ring configured to be coupled with the pipeline closure extension. In some examples, the closure hub adapter portion and the pipeline closure extension fastener ring are joined.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of a pipeline closure coupling assembly according to at least one example of the present disclosure.

FIG. 2 is a cross section of a pipeline closure coupling assembly as illustrated in FIG. 1 according to at least one example of the present disclosure.

FIG. 3A is a cross section of an example of the pipeline closure coupling assembly as illustrated in FIG. 1 including a fastener according to at least one example of the present disclosure.

FIG. 3B is an example of the pipeline closure coupling assembly as illustrated in FIG. 1 including a fastener according to at least one example of the present disclosure.

FIG. 4 is a close-up cross-sectional view of an abutment region according to at least one example of the present disclosure.

FIG. 5A illustrates a step in assembling the pipeline closure coupling assembly of FIG. 1 according to at least one example of the present disclosure.

FIG. 5B illustrates a step in assembling the pipeline closure coupling assembly of FIG. 1 according to at least one example of the present disclosure.

FIG. 5C illustrates a step in assembling the pipeline closure coupling assembly of FIG. 1 according to at least one example of the present disclosure.

FIG. 5D illustrates a step in assembling the pipeline closure coupling assembly of FIG. 1 according to at least one example of the present disclosure.

### DETAILED DESCRIPTION

The present application, in one or more examples, relates to a coupling assembly that can be used to attach a pipeline closure to a hub, port, or other access point of a pipeline, a refinery, or other piping system. The coupling assembly may be configured for engagement with threads on the hub. The coupling assembly may provide for adjustability between the pipeline closure and the hub such that when installing, later tightening, or otherwise adjusting the connection. The pipeline closure may be maintained or adjusted to a proper angular alignment allowing for proper functionality of the closure hub door and/or other features.

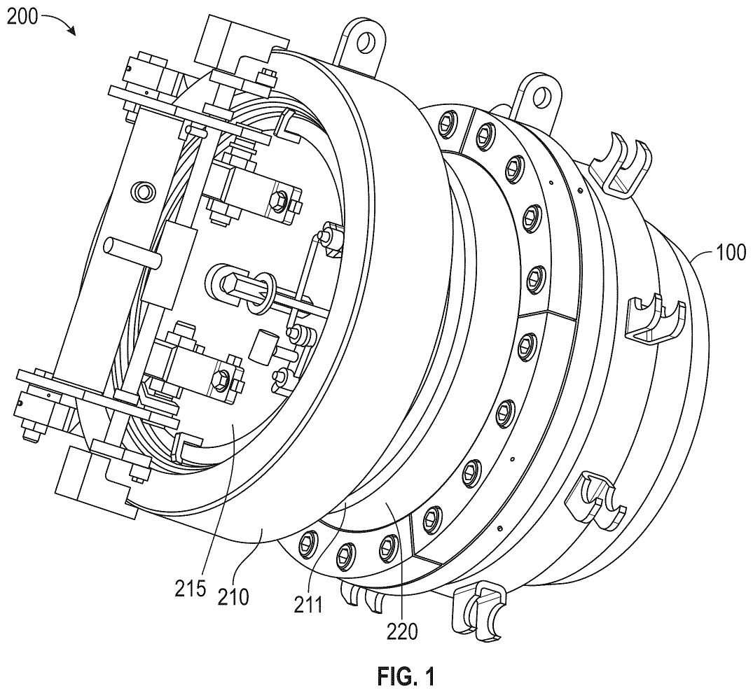

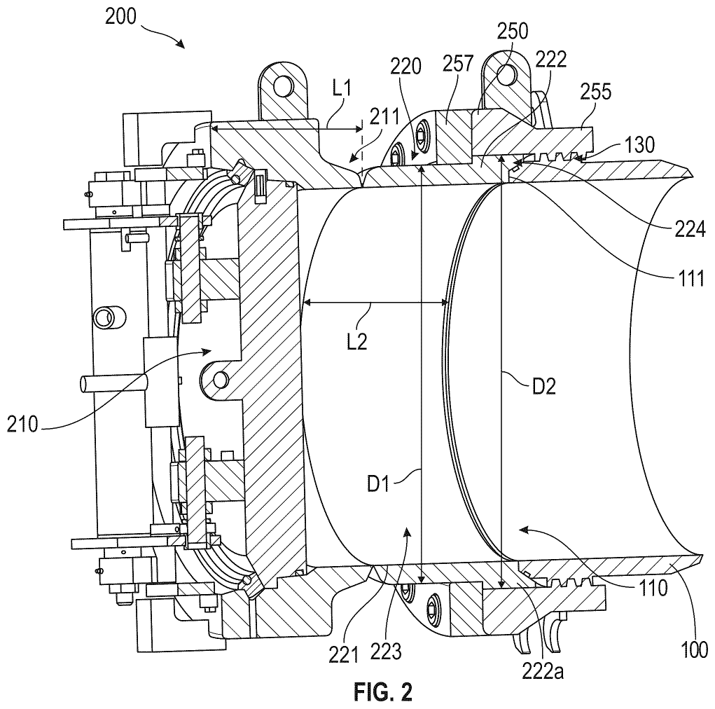

FIG. 1 illustrates a closure hub 100 of an existing pipeline (e.g., tubular) and a coupling assembly 200. The closure hub 100 is, for example, a terminal portion of a pipeline. The closure hub 100 defines, for example, an opening 110 (as described in further detail as related to FIG. 2) providing access to at least a portion of the internal structure of the pipeline. In an example, the coupling assembly 200 includes an assembly that replaces a previously installed (e.g., attached, connected, coupled, joined or the like) closure.

The coupling assembly 200 can include several components formed or designed to replace a previously installed (e.g., attached, connected, coupled, joined or the like) closure (hereinafter, closure will refer to a door, endcap, closure, covering or the like). For example, each of the components of the coupling assembly 200 is joined in a shop or facility offsite from the location of the pipeline. Assembling the coupling assembly 200 offsite can provide for better or more secure coupling or more accurate machining of the component parts. The coupling assembly 200, including at least some of the components, is then connected with the closure hub 100 of the existing pipeline.

The coupling assembly 200, for example, is designed or formed to connect a pipeline closure 210, as a replacement or compatible closure, to the existing pipeline, such as at the closure hub 100. The pipeline closure 210, when connected with the existing pipeline closure hub 100, for example, provides access to interior structures of the pipeline. In an example, the pipeline closure 210 includes a door 215 as the mechanism for accessing interior structures of the existing pipeline.

In an example, the closure 210 includes a door 215 having a locking coupling. In some examples, the locking coupling includes a locking mechanism that includes one or more bands or rings that can be tightened around the closure hub or the closure, such as a BANDLOCK™ style closure. In other examples, the closure includes a clamp style closure. The locking coupling or the clamp style closures provide, in examples, an access that can be securely opened or closed on structures used in high-pressure applications, such as pipelines that transport petroleum. For example, a locking coupling or clamp style closure, provides a closure that seals the opening of the pipeline. In examples, the locking coupling or clamp style closure includes mechanisms that, when properly aligned, close or seal the closure hub 100.

In examples, when a closure is removed from the pipeline, or is first being installed, it may be difficult to properly realign the locking coupling or clamp mechanisms. Since the locking coupling or clamp mechanism functions similar to a door with a vertical hinge, if the hinge is not arranged substantially plumb, the locking coupling or clamp style mechanism may be difficult to open or dangerous to open. In an example, the coupling assembly 200 including a pipeline closure extension 220 and a closure that is a locking coupling or clamp closure, may remain more readily aligned and where later tightening of the closure relative to the closure hub 100 is performed, the locking coupling or clamp mechanism can be realigned relatively easily.

The coupling assembly 200 includes, for example, the pipeline closure extension 220 coupled to the pipeline closure 210. In the example illustrated in FIG. 2, the pipeline closure extension 220 is an attachment that is coupled with a rear side 211 of the pipeline closure 210. For example, the rear side 211 of the pipeline closure 210 is the side of the pipeline closure 210 that faces the opening 110 of the closure hub 100.

The pipeline closure extension 220 is, for example, a tubular or cylindrical structure with a dimension similar to the diameter of the opening 110 of the closure hub 100. In examples, the pipeline closure extension 220 has the same or similar diameter from first side 221 of the pipeline closure extension 220 to the second side 222 of the pipeline closure extension 220. In another example, the pipeline closure extension 220 includes a varying diameter between the first side 221 to the second side 222 of the pipeline closure extension 220, for example with second side 222 of the pipeline closure 210 having a diameter matching, or approximately matching the diameter of the opening 110 of the closure hub 100.

The length L2 of the pipeline closure extension 220 is optionally defined according to the specified purpose. For example, the pipeline closure extension 220 extends a length L2 similar to the length L1 of the pipeline closure 210. In other examples, the pipeline closure extension 220 has a length L2 longer than the length L1 of the pipeline closure 210. In another example, the pipeline closure extension 220 has a length L2 shorter than the length L1 of the pipeline closure 210.

In an example, pipeline closure 210 is a separate component from the pipeline closure extension 220. The pipeline closure extension 220 is coupled with the pipeline closure 210 with a mechanical means, such as threads, screws, bolts, rivets, welding, tight-fit, adhesives or the like. For example, the pipeline closure extension 220 can be coupled with the pipeline closure 210 by welding the rear side 211 of the pipeline closure 210 with the first side 221 of the pipeline closure extension 220. In another example, the rear side 211 of the pipeline closure 210 is mechanically joined the first side 221 of the pipeline closure extension 220. For example, the rear side 211 of the pipeline closure 210 and the first side 221 of the pipeline closure extension 220 have mating threaded engagements. In another example rear side 211 of the pipeline closure 210 and the first side 221 of pipeline closure extension 220 are joined with a threaded connection, bolts, or tight-fit mating surfaces. In some examples, a seal is placed proximate to or within the connection to minimize or prevent leakage.

In one example, the first side 221 of the pipeline closure extension 220 is welded with the rear side 211 of the pipeline closure 210 with a girth weld. In examples, the pipeline closure extension 220 and the pipeline closure 210 are joined to form a unitary structure. For instance, the pipeline closure 210 with the pipeline closure extension 220 welded together forms a structure that minimizes or prevents leakage of fluid from the pipeline to the environment.

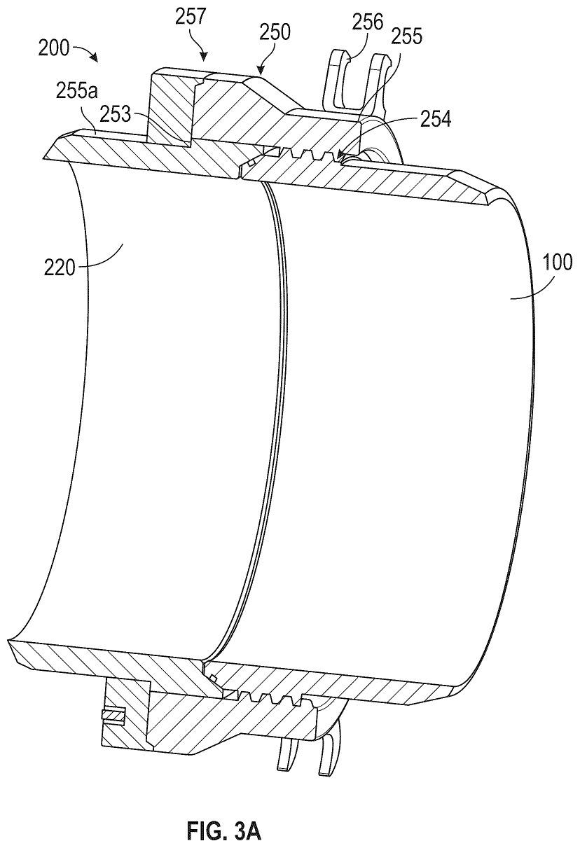

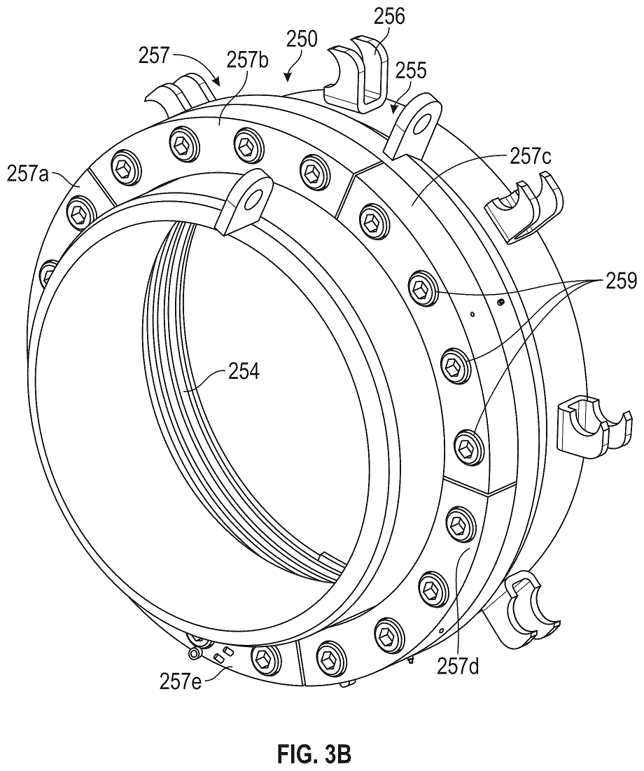

Illustrated in FIGS. 3A and 3B are examples of the coupling assembly 200 including a fastener 250 attached to the closure hub 100. The fastener 250 has, for example, a closure hub adapter portion 255 that can be coupled with a threaded region 130 of a closure hub 100. For example, the closure hub adapter portion 255 has a threaded interior face 254 that includes a mating thread to the threaded region 130. The closure hub adapter portion 255 is optionally machined, molded, formed or the like to be a threaded connection portion of the fastener 250. Optionally, the closure hub adapter portion 255 includes the threaded interior face 254 to join the pipeline closure 210 with the closure hub 100. The threaded interior face 254 is optionally formed to be tightened over time without removing the pipeline closure 210 from the closure hub 100 minimizing occurrences of misalignment of clamps or mechanisms of the pipeline closure 210.

Optionally, the closure hub adapter portion 255 includes one or more lugs 256 placed around the exterior portion of the closure hub adapter portion 255. The one or more lugs 256 can assist in facilitating tightening the fastener 250 with closure hub 100. In some examples the one or more lugs 256 are used to rotate the coupling assembly 200, or at least the fastener portion, onto the closure hub 100. In some examples, the one or more lugs 256 are protrusions that extend from the exterior surface of the closure hub adapter portion 255. The one or more lugs 256 can provide engagements for an external tool to apply force to rotate the coupling assembly 200 with the closure hub 100. In other examples, recesses, protrusions or other mechanical engagements are used to assist in rotation and mating the threads of the fastener 250 with the threaded region 130.

The fastener 250 optionally includes a pipeline closure extension fastener ring 257. The pipeline closure extension fastener ring 257 assists in retaining the pipeline closure extension 220 when the pipeline closure extension 220 is placed in an abutting configuration with the closure hub 100. For example, the pipeline closure extension fastener ring 257 is a clamp, plate, flange or similar coupling or structure that can be joined with a coupling surface 255a of the closure hub adapter portion 255. For example, the coupling surface 255a is a flange of the closure hub adapter portion 255. The coupling surface 255a, for example, receives one or more fastening components 259 to join the pipeline closure extension fastener ring 257 with the closure hub adapter portion 255. One or more fastening components 259 includes, for example, bolts, screws or the like. The one or more fastening components 259 assist in securing the pipeline closure extension fastener ring 257 with the closure hub adapter portion 255. For example, the pipeline closure extension fastener ring 257 is rotationally secured with the closure hub adapter portion 255.

In an example, the pipeline closure extension fastener ring 257 includes one or more pipeline closure extension fasteners 257a, 257b, 257c, 257d, 257e positioned around the perimeter of the pipeline closure extension 220 and attached with the closure hub adapter portion 255. Each of the one or more pipeline closure extension fasteners 257a, 257b, 257c, 257d, 257e can be separately coupled with the closure hub adapter portion 255. Having one or more pipeline closure extension fasteners 257a, 257b, 257c, 257d, 257e, for example, facilitates ease in coupling the pipeline closure extension fastener ring 257 with the closure hub adapter portion 255. Optionally, using one or more separate pipeline closure extension fasteners 257a, 257b, 257c, 257d, 257e can allow one person to couple each of the one or more pipeline closure extension fasteners 257a, 257b, 257c, 257d, 257e with the closure hub adapter portion 255. While five pipeline closure extension fasteners 257a, 257b, 257c, 257d, 257e are illustrated in FIG. 3B, any number of individual pipeline closure extension fasteners 257 can be used.

In some examples, the one or more pipeline closure extension fasteners 257a, 257b, 257c, 257d, 257e cooperate to form an annular shaped clamp. For instance, each of the pipeline closure extension fasteners 257a, 257b, 257c, 257d, 257e has an arcuate profile and each are placed in abutment with an adjacent pipeline closure extension fastener. In another example, each of the pipeline closure extension fasteners 257a, 257b, 257c, 257d, 257e is placed with a space extending between an adjacent pipeline closure extension fasteners 257a, 257b, 257c, 257d, 257e. The one or more pipeline closure extension fasteners 257a, 257b, 257c, 257d, 257e can cooperate to brace (e.g., clamp, secure, clasp, fix) the pipeline closure extension 220 with the closure hub adapter portion 255.

FIG. 3A is an example of the pipeline closure extension fastener ring 257 coupled with the pipeline closure extension 220 having a sliding fit retention of the pipeline closure extension 220 with the fastener 250. The sliding fit relationship joins (e.g., retains, couples, mates, or the like) the pipeline closure extension 220 between the fastener 250 and the closure hub 100. For example, the pipeline closure extension fastener ring 257 includes an extension 253 that mates with a portion the second side 222 of the pipeline closure extension 220. Mating the extension 253 and the second side 222 extension can minimize a likelihood of the pipeline closure extension 220 from sliding away or disengaging from the closure hub 100. For example, the extension 253 in connection with the second side 222 provides a region where the pipeline closure extension fastener ring 257 is secured with the closure hub adapter portion 255.

Referring back to FIG. 2, a second side 222 of the pipeline closure extension 220 can be positioned to contact at least a portion of the closure hub 100 of an existing pipeline. The portion of the pipeline closure extension 220 extending between the first side 221 and the second side 222 includes a barrel, or tubular, central extension portion 223. The central extension portion 223 optionally has an outer diameter that is consistent along the length L2. In other examples the central extension portion 223 includes portions that have an outer diameter greater than other portions of the central extension portion 223. As illustrated in FIG. 2, the central extension portion 223 includes a first outer diameter D1 at a portion of the central extension portion 223. The area of the pipeline closure extension 220 including the second side 222 has, for example, a second outer diameter D2. The second side 222 includes the second outer diameter D2 greater than the first outer diameter D1 such that a shoulder is formed that defines the extension 253.

In an example, as illustrated in FIG. 2, the pipeline closure extension 220 has a second, larger outer diameter D2 proximate to the second side 222 of the 220. An exterior portion 222a of the second side 222 optionally includes a junction portion 224. In an example, the junction portion 224 has a larger diameter, such as outer diameter D2, than the first outer diameter D1. The junction portion 224 is, for example, a portion of the pipeline closure extension 220 that is positioned in abutting relationship with the closure hub 100. For example, the closure hub 100 defines a circumference of an opening 110. In an example, the junction portion 224 includes an area of the second side 222 of the pipeline closure extension 220 that, for example, is angled to abut a corresponding angle of the closure hub 100.

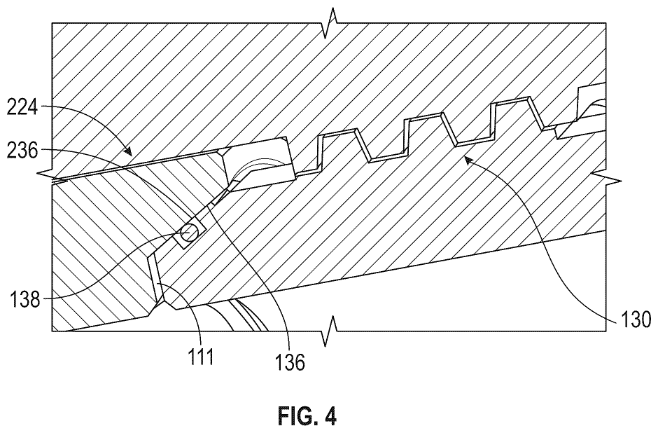

As illustrated in FIG. 4, the junction portion 224 includes an abutting portion 236. The abutting portion 236, for example, includes an angled surface. In another example, the abutting portion 236 is acutely angled, obtusely angled or has an approximately right angle. The abutting portion 236 faces a corresponding opening surface 136 of the closure hub opening 110. Optionally, the corresponding opening surface 136 is an angled surface that is correspondingly angled to the abutting portion 236.

In an example, the abutting portion 236 is a sealing surface when in abutment with the corresponding opening surface 136 as a sealing surface of the opening 110 (the opening 110 illustrated in FIG. 2). In examples, the abutting portion 236 extends at least partially along the corresponding opening surface 136. For instance, the abutting portion 236 terminates proximate to a threaded region 130 of the closure hub 100. In an example, an outer diameter of the junction portion 224 is similar to an outer diameter of the threads of the threaded region 130. Optionally, a seal 138 is placed between the abutting portion 236 and the corresponding opening surface 136. The seal 138 is, for example, an additional seal component between the closure hub 100 and the pipeline closure 210. In other examples, other sealing components such as mating rings, diaphragms, elastomers or the like are positioned between the junction portion 224 and the opening 110, such as on the corresponding opening surface 136.

Referring to FIG. 2 and FIG. 4, the corresponding opening surface 136, as an angled surface, is an example of a portion of the opening 110 that extends from a rim 111 of the closure hub 100 to, optionally, the threaded region 130. The threaded region 130 is, for example, a connection for a previous closure or cap. The previous closure is, for example, replaced with the coupling assembly 200 and the pipeline closure 210. The coupling assembly 200 is an example of an adapter to join the new pipeline closure 210 with the closure hub 100. The coupling assembly 200 is joined with the closure hub 100 by mating the threaded region 130 with a fastener 250.

In an example, the coupling assembly 200 with the pipeline closure 210 on one end and the closure hub 100 on another end, minimizes the locations where fluid can leak from the coupling assembly 200. For example, by welding the pipeline closure extension 220 with the pipeline closure 210 there may be one location for possible leakage in that part of the system, such as the area surrounding the pipeline closure 210. In another example, leakage can be minimized by having one area such as the point where the pipeline closure extension 220 abutting portion 236 abuts with the closure hub 100 abutting portion 236.

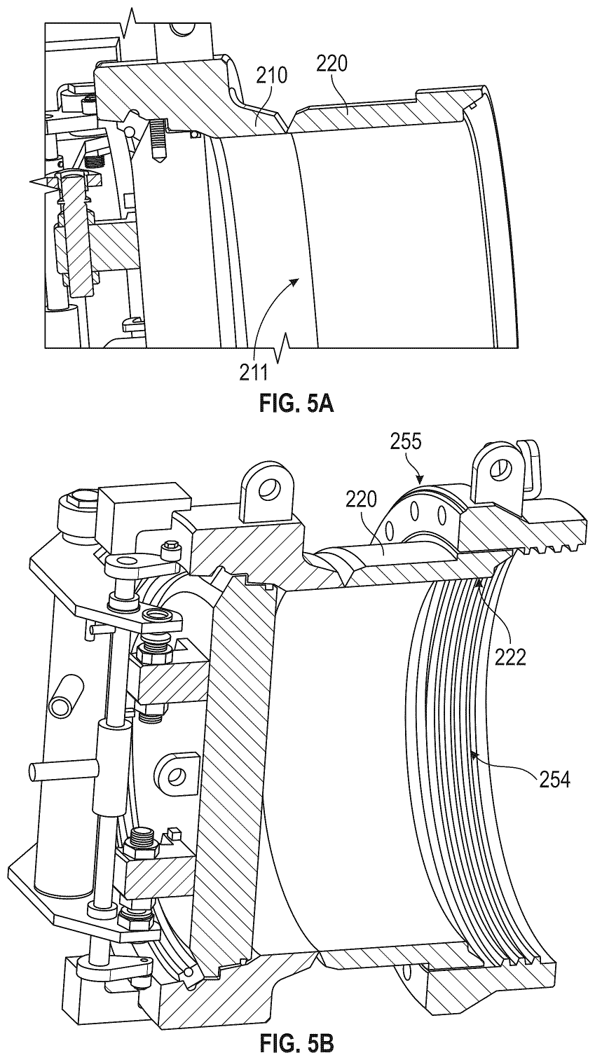

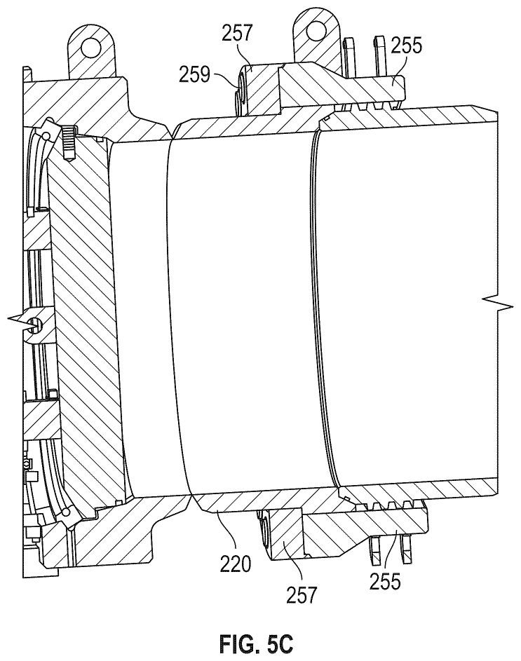

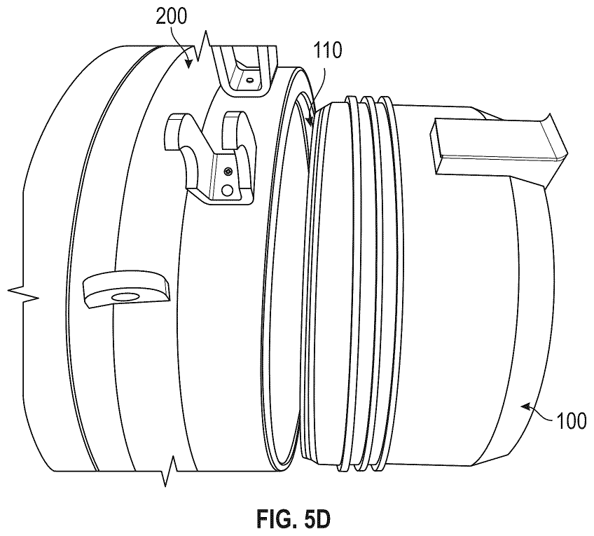

FIGS. 5A-5D show stages of a method of joining a pipeline closure 210 with an existing pipeline closure hub 100. For example, as illustrated in FIG. 5A, a pipeline closure 210 is coupled with the pipeline closure extension 220. For example, the pipeline closure extension 220 is coupled to a rear side 211 of the pipeline closure 210. The pipeline closure extension 220 is coupled with the pipeline closure 210 by welding. For example, a girth weld couples the pipeline closure extension 220 and the pipeline closure 210. In other examples, the pipeline closure extension 220 and the pipeline closure 210 are coupled with mechanical fasteners, adhesives, welding or the like.

As illustrated in FIG. 5B, the closure hub adapter portion 255 is in engagement with the pipeline closure extension 220 proximate to the second side 222. In examples, the pipeline closure extension 220 is brought into a couplable relationship with the closure hub adapter portion 255. For example, the pipeline closure extension 220 is placed into an opening in the closure hub adapter portion 255 from a position proximate to the closure hub adapter portion 255. For instance, the closure hub adapter portion 255 is positioned on an external surface of the pipeline closure extension 220 such that the closure hub adapter portion 255 is sleevably engaged with the pipeline closure extension. In an example, the closure hub adapter portion 255 is fixed, coupled or otherwise retained on at least a portion of the pipeline closure extension 220. In an example, the threaded interior face 254 engages with threaded region 130 of the opening 110 the existing pipe and pulls on the closure hub adapter portion 255 to drive the pipeline closure extension 220 into sealing engagement with the existing pipe. For example, there is a freedom of movement between the pipeline closure extension 220 and the closure hub adapter portion 255.

As illustrated in FIG. 5C, a pipeline closure extension fastener ring 257 is optionally arranged on an external surface of the pipeline closure extension 220. The pipeline closure extension fastener ring 257 is coupled with the closure hub adapter portion 255. For example, the pipeline closure extension fastener ring 257 is coupled with the closure hub adapter portion 255 with one or more fastening components 259. In an example, the pipeline closure extension 220 is slidably retained and drawn against the closure hub 100 by the pipeline closure extension fastener ring 257.

Illustrated in FIG. 5D is an example of the coupling assembly 200 approaching an opening 110 of the closure hub 100. For example, as illustrated in FIG. 4, the pipeline closure extension 220 has an abutting portion 236 that abuts a corresponding opening surface 136, as an angled surface, of the closure hub 100. When the abutting portion 236 of the pipeline closure extension 220 is placed in abutting relationship with the corresponding opening surface 136, as an angled surface, the pipeline closure extension 220 is placed in a sealing arrangement against the opening 110.

In an example, the sealing arrangement includes placing a seal between the abutting portion 236 of the pipeline closure extension 220 and the corresponding opening surface 136, as an angled surface. The sealing arrangement, optionally, is formed with a seal that was associated with the closure hub 100 and remained in place on the closure hub. In other examples, a new seal is placed between the abutting portion 236 of the pipeline closure extension 220 and the corresponding opening surface 136, as an angled surface, as illustrated in detail in FIG. 4.

In an example, the closure hub adapter portion 255 includes a threaded interior face 254 that is arranged in mating relationship with a threaded region 130 of the closure hub 100. The closure hub adapter portion 255 when brought into mating relationship with the closure hub 100 is rotated to tighten the closure hub adapter portion 255 with the closure hub 100. Moreover, the one or more lugs 256 may be engaged to allow a suitable torque to be applied to the closure hub adapter portion 255. In one or more examples, the one or more lugs 256 may be engaged with a tool.

### VARIOUS NOTES AND ASPECTS

Aspect 1 can include subject matter such as a coupling assembly connecting a pipeline closure with an existing pipeline closure hub, the existing pipeline closure hub having an external coupling portion and defining an opening portion, the assembly comprising: a pipeline closure extension extending from the pipeline closure, the pipeline closure extension configured to be positioned in an abutting relationship with the opening portion, the pipeline closure extension including: a junction portion including an abutting portion configured to abut the opening portion; and a fastener, the fastener extending around the junction portion, the fastener including: a closure hub adapter portion coupled with the coupling portion; and a pipeline closure extension fastener ring coupled with the pipeline closure extension; wherein the closure hub adapter portion and the pipeline closure extension fastener ring are joined.

Aspect 2 can include, or can optionally be combined with the subject matter of Aspect 1, to optionally include the junction portion has a larger diameter than a diameter of the pipeline portion extension proximate to the pipeline closure, the junction portion including: an abutment face on the pipeline closure extension; wherein the abutment face is configured to form a seal with an opposing abutment face on the pipeline closure hub.

Aspect 3 can include, or can optionally be combined with the subject matter of one or any combination of Aspects 1 or 2 to optionally include the fastener includes coupling portions configured to couple pipeline closure extension with the pipeline closure hub; wherein the fastener is configured to engage with the junction portion.

Aspect 4 can include, or can optionally be combined with the subject matter of one or any combination of Aspects 1-3 to optionally include the closure hub adapter includes a threaded region configured to mate with a threaded face of the coupling portion.

Aspect 5 can include, or can optionally be combined with the subject matter of one or any combination of Aspects 1-4 to optionally include the pipeline closure extension includes an angled abutment surface.

Aspect 6 can include, or can optionally be combined with the subject matter of one or any combination of Aspects 1-5 to optionally include the pipeline closure extension is welded to the pipeline closure.

Aspect 7 can include, or can optionally be combined with the subject matter of one or any combination of Aspects 1-6 to optionally include the pipeline closure extension fastener ring is joined with the closure hub adapter portion with one or more fastening components.

Aspect 8 can include subject matter such as a pipeline closure adapter comprising: a pipeline closure extension including an outer surface, the pipeline closure extension welded to a pipeline closure at a first portion of the pipeline closure extension and having an abutting portion at a second portion of the pipeline closure extension, the abutting portion having an abutting face, the abutting face configured to contact a corresponding opening surface of a closure hub; and a fastener configured to secure the pipeline closure extension to the pipeline closure hub, the fastener including: a pipeline closure hub adapter portion including a mating surface; wherein the mating surface contacts at least a portion of an external surface of the pipeline closure hub; and a pipeline closure extension fastener ring portion including a flange portion and an internal surface facing the pipeline closure extension outer surface; wherein the pipeline closure fastener portion is coupled with the pipeline closure extension fastener ring portion to secure the pipeline closure extension to the closure hub.

Aspect 9 can include, or can optionally be combined with the subject matter of Aspect 8, to optionally include the abutting face is configured to form a seal against a corresponding pipeline closure hub abutting face.

Aspect 10 can include, or can optionally be combined with the subject matter of Aspect 8 to 9, to optionally include the mating surface includes a threaded portion; wherein the threaded portion includes a corresponding thread to a thread on the pipeline closure hub.

Aspect 11 can include, or can optionally be combined with the subject matter of Aspect 8-10, to optionally include the pipeline closure hub adapter is configured to rotate around an external surface of the pipeline closure hub.

Aspect 12 can include, or can optionally be combined with the subject matter of Aspect 8 to 11, to optionally include the pipeline closure hub adapter portion and the pipeline closure extension fastener ring are coupled with one or more of bolts or screws.

Aspect 13 can include, or can optionally be combined with the subject matter of Aspect 8 to 12, to optionally include the pipeline closure extension is slidably retained with the pipeline closure extension fastener.

Aspect 14 can include subject matter such as a method of joining a pipeline closure with a pipeline closure hub, the method including; coupling a pipeline closure extension with the pipeline closure; placing the pipeline closure extension in abutting relationship with an opening portion of the pipeline closure hub; sleevably engaging a closure hub adapter portion on the external surface of the pipeline closure extension; arranging a pipeline closure extension fastener ring onto an external surface of the pipeline closure hub; and coupling the pipeline closure extension fastener ring to the closure hub adapter to secure the pipeline closure extension to the closure hub.

Aspect 15 can include, or can optionally be combined with the subject matter of Aspect 14, to optionally include forming a seal between the pipeline closure extension and the pipeline closure hub; sealing the pipeline closure extension against the opening portion; and fixing a fastener on an external surface of the pipeline closure extension.

Aspect 16 can include, or can optionally be combined with the subject matter of Aspect 14 or 15, to optionally include threading the pipeline closure hub adapter on the pipeline closure hub.

Aspect 17 can include, or can optionally be combined with the subject matter of Aspect 14 to 16, to optionally include coupling the closure hub adapter portion with the pipeline closure extension includes securing with at least one of bolts or screws.

Aspect 18 can include, or can optionally be combined with the subject matter of Aspect 14 to 17, to optionally include replacing an existing coupling joining the pipeline closure with the pipeline closure hub with the pipeline closure extension.

Aspect 19 can include, or can optionally be combined with the subject matter of Aspect 14 to 18, to optionally include arranging the closure hub adapter portion in mating relationship with the closure hub; and rotating the closure hub adapter portion coupled to the pipeline closure extension tightens the closure hub adapter portion with the closure hub.

Aspect 20 can include, or can optionally be combined with the subject matter of Aspect 14 to 20, to optionally include slidably retaining the pipeline closure extension in one or more of the pipeline closure extension fastener ring and the closure hub adapter.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A coupling assembly connecting a pipeline closure with an existing pipeline closure hub, the existing pipeline closure hub having an external coupling portion and defining an opening portion, the coupling assembly comprising:
a pipeline closure extension extending from the pipeline closure, the pipeline closure extension configured to be positioned in an abutting relationship with the opening portion, the pipeline closure extension including:
a junction portion including an abutting portion configured to abut the opening portion; and
a fastener, the fastener extending around the junction portion, the fastener including:
a closure hub adapter portion coupled with the external coupling portion; and
a pipeline closure extension fastener ring coupled with the pipeline closure extension;
wherein the closure hub adapter portion and the pipeline closure extension fastener ring are joined.

2. The coupling assembly of claim 1, wherein the junction portion has a larger diameter than a diameter of the pipeline closure extension proximate to the pipeline closure, the junction portion including:
an abutment face on the pipeline closure extension;
wherein the abutment face is configured to form a seal with an opposing abutment face on the existing pipeline closure hub.

3. The coupling assembly of claim 1, wherein the fastener includes coupling portions configured to couple the pipeline closure extension with the existing pipeline closure hub;
wherein the fastener is configured to engage with the junction portion.

4. The coupling assembly of claim 1, wherein the closure hub adapter portion includes a threaded region configured to mate with a threaded face of the external coupling portion.

5. The coupling assembly of claim 1, wherein the pipeline closure extension includes an angled abutment surface.

6. The coupling assembly of claim 1, wherein the pipeline closure extension is welded to the pipeline closure.

7. The coupling assembly of claim 1 wherein the pipeline closure extension fastener ring is joined with the closure hub adapter portion with one or more fastening components.

8. A pipeline closure adapter comprising:
a pipeline closure extension including an outer surface, the pipeline closure extension welded to a pipeline closure at a first portion of the pipeline closure extension and having an abutting portion at a second portion of the pipeline closure extension, the abutting portion having an abutting face, the abutting face configured to contact a corresponding opening surface of a pipeline closure hub; and
a fastener configured to secure the pipeline closure extension to the pipeline closure hub, the fastener including:
a pipeline closure hub adapter portion including a mating surface;
wherein the mating surface contacts at least a portion of an external surface of the pipeline closure hub; and
a pipeline closure extension fastener ring portion including a flange portion and an internal surface facing an outer surface of the pipeline closure extension;
wherein the pipeline closure hub adapter portion is coupled with the pipeline closure extension fastener ring portion to secure the pipeline closure extension to the pipeline closure hub.

9. The pipeline closure adapter of claim 8, wherein the abutting face is configured to form a seal against a corresponding pipeline closure hub abutting face.

10. The pipeline closure adapter of claim 8, wherein the mating surface includes a threaded portion;
wherein the threaded portion includes a corresponding thread to a thread on the pipeline closure hub.

11. The pipeline closure adapter of claim 8, wherein the pipeline closure hub adapter portion is configured to rotate around the outer surface of the pipeline closure hub.

12. The pipeline closure adapter of claim 8, wherein the pipeline closure hub adapter portion and the pipeline closure extension fastener ring portion are coupled with one or more of bolts or screws.

13. The pipeline closure adapter of claim 8, wherein the pipeline closure extension is slidably retained with the pipeline closure extension fastener ring portion.

14. A method of joining a pipeline closure with a pipeline closure hub, the method including;
coupling a pipeline closure extension with the pipeline closure;
placing the pipeline closure extension in abutting relationship with an opening portion of the pipeline closure hub;
sleevably engaging a closure hub adapter portion on an external surface of the pipeline closure extension;
arranging a pipeline closure extension fastener ring onto an external surface of the pipeline closure hub; and
coupling the pipeline closure extension fastener ring to the closure hub adapter portion to secure the pipeline closure extension to the pipeline closure hub.

15. The method of joining the pipeline closure of claim 14, including:
forming a seal between the pipeline closure extension and the pipeline closure hub;
sealing the pipeline closure extension against the opening portion; and
fixing a fastener on an external surface of the pipeline closure extension.

16. The method of joining the pipeline closure of claim 14, including threading the closure hub adapter portion on the pipeline closure hub.

17. The method of joining the pipeline closure of claim 14, wherein coupling the closure hub adapter portion with the pipeline closure extension includes securing with at least one of bolts or screws.

18. The method of joining the pipeline closure of claim 14, including replacing an existing coupling joining the pipeline closure with the pipeline closure hub with the pipeline closure extension.

19. The method of joining the pipeline closure of claim 14, including:
arranging the closure hub adapter portion in mating relationship with the pipeline closure hub; and
rotating the closure hub adapter portion coupled to the pipeline closure extension tightens the closure hub adapter portion with the pipeline closure hub.

20. The method of joining the pipeline closure of claim 14, including slidably retaining the pipeline closure extension in one or more of the pipeline closure extension fastener ring and the closure hub adapter portion.
